(19) United States
(12) Patent Application Publication
(10) Pub. No.: US 2010/0040824 A1
(43) Pub. Date: Feb. 18, 2010

(54) Threaded Connector Formed On A Surface

(75) Inventor: Donald C. Albin, JR., Carlisle, PA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: International Automotive Components Group North America, Inc., Dearborn, MI (US)

(21) Appl. No.: 12/190,089

(22) Filed: Aug. 12, 2008

(51) Int. Cl. B32B 33/00; B29C 59/00; B29C 47/76; B29C 49/00

(52) U.S. Cl. 428/96; 264/293; 264/101; 264/544

(57) ABSTRACT

The present invention is directed at an apparatus and method for attaching articles to surfaces, and more particularly to fibrous surfaces, such as carpeting. A polymeric sheet having a peripheral flange including a bonding surface, as well as a raised portion, may be bonded to the fiber surface. The raised portion may then include threads for attachment purposes.

### FIELD

The present disclosure relates to an apparatus and method for attaching articles to surfaces, and more particularly to fibrous surfaces, such as carpeting, by way of a threaded connector positioned directly on the fibrous surface.

### BACKGROUND

With the demand for quality, comfort and aesthetic beauty regulating vehicle construction and design, including a vehicle's interior, vehicle manufacturers have responded by decorating vehicle interior floor boards with a substantially unitary piece of carpet having a size and configuration that covers nearly the entire floor board and as well as a portion of the vehicle interior. This may include even the trunk area and for sports utility vehicles (SUV's), minivans and “cross-over” vehicles may cover the cargo storage areas behind the second or third row of seats as well.

Vehicle floor coverings are typically configured to provide a resilient and decorative wearing surface with heat insulating and sound deadening qualities. For example, the use of carpet as a vehicle floor covering is well known. Carpeting used to cover a vehicle floor is typically molded into a contoured configuration that conforms to the contour of a vehicle floor so as to fit properly. U.S. Pat. No. 4,579,764 to Peoples, Jr., et al. discloses an exemplary molded foam-backed carpet for use as a vehicle floor covering. The carpet so-formed may have a plurality of fibers, such as tufted fibers, protruding from the top surface to which, until now, it has been difficult to provide a solid and reasonably strong attachment.

In today's society, automobiles are utilized to transport more than just adults, children and sports equipment. A multitude of items, such as groceries, automobile safety equipment, toys, first aid equipment and/or sporting goods, typically may be found in an automobile. However, many of these items can be damaged and/or cause damage to the interior of an automobile by sliding around uncontrollably during driving and thus striking the interior portions of the automobile cargo area. Accordingly, there is a need for securing or tying down articles to keep them from sliding around.

In addition, it may be desirable to locate and secure such items as cup holders, trays, access points, terminals and docking stations on the floor, sidewall or tunnel surfaces of the vehicle at a convenient location for use.

### SUMMARY

In a first exemplary embodiment, the invention is directed at a fibrous surface including a connector for attaching articles, comprising a fibrous surface including fibers protruding therefrom and a polymeric sheet having a peripheral flange. The flange may have a bonding surface to bond to the fibers, wherein the sheet includes a raised portion and the peripheral flange at least partially surrounds the raised portion of the sheet. The bonding surface of the peripheral flange is bonded to the fibrous surface, and the raised portion of the sheet includes a surface comprising threads.

In another exemplary embodiment, the present invention is directed at a method of forming a threaded connector on a surface, comprising providing a surface, providing a polymeric sheet for forming into a raised portion with a peripheral portion, and heating the sheet to a temperature where the sheet may be formed to include a raised portion and a peripheral portion and applying the sheet to the selected surface. This may then be followed by providing a tool having a threaded portion, pressing the tool into the heated sheet and forming a peripheral portion of the sheet to contact and bond to the surface, wherein a portion of the sheet is formed into a raised portion, and unthreading the tooling from the formed sheet.

In another exemplary embodiment the present invention is directed at a method of forming a connector on a surface, comprising providing a surface, providing a polymeric sheet for forming into a raised portion with a peripheral portion and heating the sheet to a temperature where the sheet may be formed to include a raised portion and a peripheral portion and applying said sheet to the selected surface. This may be followed by providing a tool having a concave portion, pressing the tool into the heated sheet and forming a peripheral portion of the sheet to contact and bond to the surface, wherein a portion of the sheet is formed into a raised portion, removing the tooling from the formed sheet and forming the raised potion into a connector.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a perspective view showing an exemplary molded floor covering assembly for a vehicle incorporating a formed threaded connector in accordance with the disclosure;

FIG. 2A is a sectional view of FIG. 1 taken along lines 2-2;

FIG. 2B is a sectional view of another embodiment illustrating a threaded connector with female threads, according to the present invention;

FIGS. 3A-D illustrates other shapes for the connector in accordance with the disclosure; and

FIG. 4 illustrates method steps for producing the formed threaded connector.

### DETAILED DESCRIPTION

The present disclosure relates both to a method and article for attaching items to an outer surface, particularly to articles having a fibrous exposed surface, and more particularly carpeting. A heated sheet of polymeric material (e.g. thermoplastic material) may be applied to the fibrous surface, where the fibers are capable of supporting the sheet. Tooling may be applied to the sheet wherein portions of the sheet are pressed into the fibers and portions of the sheet remain supported by the fibers. The tooling may also develop threads on the sheet on that portion of the sheet that projects from the fiber surface. The threaded portion may then serve as an interface for attaching articles to the carpet, fibrous surface, flat surface, etc. The aesthetic appearance of the underlying surface may also be maintained by using a transparent or translucent sheet (e.g. a sheet of material that may transmit 50-100% visible light).

The threaded portion may comprise male or female threads formed into the thermoplastic sheet while it is molten or in a formable state. Articles such as hooks, legs, connectors, etc. may then be threaded to the formed connector, allowing attachment of a wide range of devices. Multiple connectors may be arranged in a pattern to provide strength and structure, such as legs for a table. In another exemplary embodiment, the sheet may be formed to include one or more projecting elements which may be configured to act as attachment points. Such elements may be in the configuration of a hook, loop, “T”, or inverted “U”. The carpeting may be used to cover horizontal and/or vertical surfaces in the interior of a vehicle or in applications in an office or home.

The polymeric sheet herein may also be one that includes a partially reacted polymerization system, such that the application of heat may cause the sheet to soften, along with further polymerization (increase in molecular weight) thereby allowing the sheet to again form and polymerize to a relatively hardened state. Any one of these polymeric sheets may then be formed to shape by the application of tooling, followed by the step of allowing the sheet to cool to substantially room temperature and unthreading the tool from the cooled sheet, thereby providing a threaded attachment projecting from the surface to which articles may be attached. For surfaces having fibers, threads, tufts, pile, etc. extending therefrom, a portion of the heated sheet may be pressed into the fibrous surface such that at least some of the fibers may be embedded in to the molten sheet, thereby providing a strong bond.

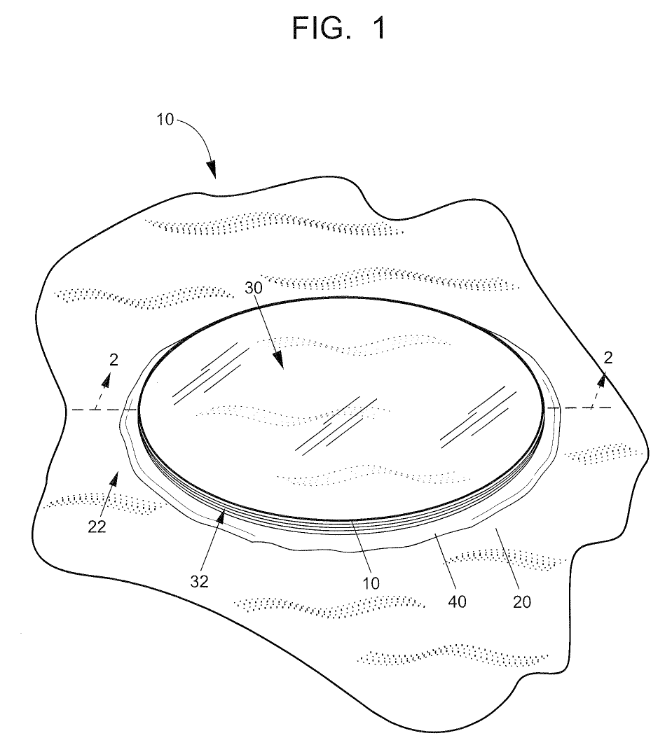

FIG. 1 is a perspective view showing a section of an exemplary molded floor covering assembly for a vehicle incorporating a formed threaded connector 10 in accordance with the present disclosure. In this exemplary embodiment, a section of carpeting 20 containing a fibrous surface for a vehicle is shown with a sheet 30 of thermoplastic attached locally at peripheral flange 40 to the fibrous surface 22 of the carpeting by pressing the sheet into the carpet with heat and pressure. A flange may therefore be understood as a section of the sheet that includes a bonding surface to bond to the fibers of the carpet, wherein the bonding surface may be heated (see below) for fiber attachment. The flange may therefore be located outboard of the threads 32.

Other methods of attachment may include but not be limited to, welding techniques such as ultrasonic, vibration, induction, hot plate conduction, electromagnetic radiation, microwave radiation, and radio frequency welding, heat staking or adhesive attachment. The sheet may be attached around all or a portion of its' peripheral flange to the carpet and may be transparent or translucent such that the carpet may be seen through the attachment. As noted above, the sheet may transmit 50-100% visible light.

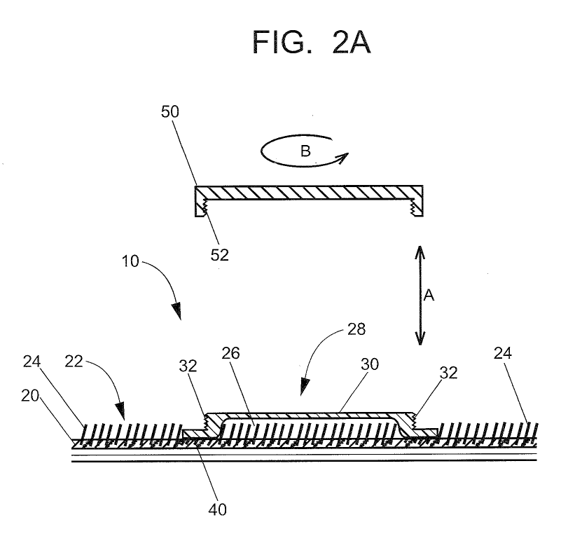

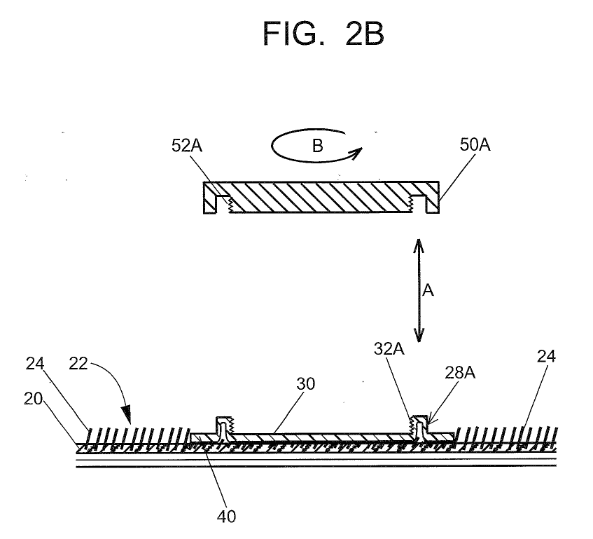

The sheet may subsequently be formed, using a tool, while hot, to include threads 32 for attachment of other articles thereto. The threads may be male or female, in the sense that the peripheral threads may be present on an outside surface of a raised portion, as shown in FIG. 2A described below (male threads) or on an inside surface of a raise portion, as shown in FIG. 2B below (female threads). One or more of such threaded attachments may be located in clusters to provide more structure to the attachment. In one exemplary embodiment, the forming tool may also be heated to improve bonding.

It is contemplated that such an attachment may be provided for nearly any relatively flat surface, but particularly for surfaces covered with fibrous materials, such as carpeting, non-woven, woven or knitted laminates, etc. Particularly for surfaces having fibers projecting therefrom, it is contemplated that at least some of the fibers may be embedded into the heated sheet when the heated sheet and fibrous surface are pressed together. The sheet of thermoplastic material, if at least partially crystalline, when applied against the fibrous or flat surface may be heated to a temperature, T, that is between the melting temperature, Tm, and the glass transition temperature, Tg, of that thermoplastic polymer. Should the sheet be an amorphous polymer or a partially reacted polymer, the sheet may be heated to a temperature where it will soften and be formed. By pressing at least a portion of the sheet, for instance, the periphery, into the fibrous surface, a relatively strong bond may be created.

In one exemplary embodiment, the surface may include upholstery fabric such as carpet that may be used on the interior of a motor vehicle. Non-woven carpet can be composed of various fiber types including, but not limited to, polyester, nylon, polypropylene, wool, cotton, and blends thereof. The sheet of thermoplastic may include any thermoplastic polymer capable of heating and forming, including but not limited to, polyester, polyolefin, polyurethane, acrylic, modified acrylic, polycarbonate, polyimide, polysulfone and blends thereof, as well as other polymers capable of meeting the process requirements for forming without deteriorating the fibrous surface, including TPO (thermoplastic olefin), TPE (thermoplastic elastomer), and ABS and blends thereof. The sheet may be about 0.141 ( 9/64) square inches in area to about 144 square inches in area and may be of any shape; round, square, rectangular, etc.

The sheet may have a thickness of from about 0.010 inches to about 0.150 inches, including all values and increments therein, in 0.010 inch increments. The sheet may be attached around all or a portion of it's periphery by methods of heat bonding, as noted above. If a relatively soft fibrous surface is being used, the pressure of bonding may allow the unbonded portion of the sheet to be supported by the fibers, pile, etc. and a threaded forming tool may be pressed onto the sheet along the bonding area, allowing the molten sheet to be formed by the threaded tool. Upon cooling of the thermoplastic sheet, the threaded tool may be unthreaded, leaving the threaded attachment of FIG. 1.

In one exemplary embodiment, the sheet comprised 0.020 inches thick Duroplex HC 99524 (modified acrylic) from Plastolite, Inc. and was formed to yield a threaded attachment that was about 3 inches in diameter and included external NPT threads. The surface to be formed upon comprised polyester carpet having a ⅜ inch pile and a threaded attachment about ⅜ inches in height was formed. The process comprised the steps of;

a) heating the sheet by radiant heat to a temperature of about 350° F.,

b) placing the sheet onto the carpeted surface,

c) providing a Teflon®-coated 3 inch diameter ring having NPT threads formed on the inside of the ½ inch wall of the ring,

d) heating the ring to 300° F.,

e) pressing the ring onto the heated sheet, forcing the ring into the carpeted surface, at a pressure of about 3500 psi.,

f) allowing the sheet to cool, and

g) unthreading the tool from the carpeted surface.

The result was the threaded connector shown in FIG. 1 wherein the carpet may still be seen through the transparent sheet.

If the bonding is to be made to a relatively hard surface, for instance, injection molded plastic, wood, etc. it may be necessary to provide a convex projection from the surface, the projection being slightly smaller than inside of the threaded tool, such that the sheet overlies the projection and is formed such it will conform into the female portion of the threaded tool. This may then allow the sheet to conform more closely to the tool and allow threads to be formed in the sheet. With fibrous surfaces, it is believed that the natural loft and resilience of the fibrous layer supports the heated sheet forming a convex projection that may be surrounded by the heat staked periphery of the sheet, the projection being accepted by the forming tool.

In addition, the threaded tool may include a connection to a source of vacuum (not shown) such that the heated sheet may be made to conform to the threads on the inside of the tool after the tool has pressed the hot sheet against the fibrous surface. Further, if a somewhat porous surface, such as carpeting, is used, it is contemplated that a source of air pressure may be used to inject air locally at the underside of the carpet in the area of the heated sheet to aid in forming the sheet into the threaded portion of the tool.

FIG. 2A is a cross-sectional view of FIG. 1 taken along lines 2-2 illustrating the carpet 20 with a molded sheet 30 of thermoplastic attached locally by peripheral flange 40 to the surface 22 of the carpet 20, wherein the sheet 30 includes threads 32 on the projection or raised portion 28 for attachment of other articles thereto. Threads may be understood as continuous grooves in an exterior surface portion of the sheet that may be utilized to attach to a corresponding threaded connector. The carpet may include fibers 24, such as pile, yarn tufts, etc. which extend from the surface 22 which may be pressed into the heated sheet 30 at 40, forming a bond. The fibers 24 in the areas where the heated sheet has not been pressed at 26 into the carpet may provide support for the sheet 30 and may provide for formation of the convex projection or raised portion 28 relative to the bonded flange portion such the projection or raised portion 28 may conform to a tool 50 having a complementary-shaped threaded portion 52. The tool 50 may be pressed (arrow A) into the hot sheet 30 compressing the sheet 30 against the surface 22 of the carpet 20, forming a bonded peripheral flange 40. The remainder of the sheet inside the tool may form a projection or raised portion 28, the sides of which may conform to the inside of the tool which tool is threaded at 52 forming threads 32 in the exterior surface of the raise portion of sheet 30 (i.e. raised above the peripheral flange 40). Once the sheet has cooled, the tool 50 may be removed from the sheet by unthreading (arrow B), to form a threaded attachment.

FIG. 2B illustrates another embodiment, wherein it may be seen that one may provide a connector 10 where the threads 32A are configured on the inside surface of a raised ring 28A. Accordingly, in this embodiment, the raised portion 28A may again be described as including a surface containing threads. In addition, as can be seen, the raised potion 28A includes a space to accommodate any protruding fibers. In this example, the threads 32A may then receive a threaded male connector, whereas it may now be appreciated that the connector noted earlier in FIG. 2A is configured to receive a threaded female connector. In this exemplary embodiment shown in FIG. 2B, the portion of the sheet inside the tool 50A may form a projection or raised portion 28A, the sides of which may conform to the inside of the tool which tool is threaded at 52A forming threads 32A in the exterior surface of the raised portion of sheet 30 (i.e. raised above the peripheral flange 40). Once the sheet has cooled, the tool 50A may be removed from the sheet by unthreading (arrow B), to form a threaded attachment.

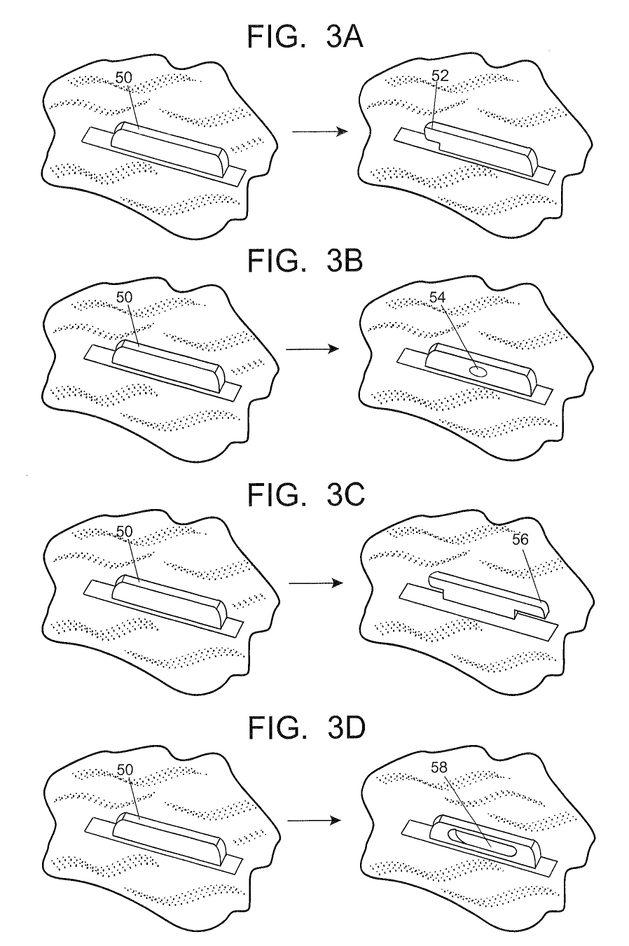

FIGS. 3A-D illustrates other shapes for the connector in accordance with the invention. FIG. 3A illustrates a projection or raised portion 50 that may be formed by pressing a tool into the molten sheet and later upon cooling and removal of the tool, cutting/drilling of the projection to form a hook portion type connector 52. FIG. 3B illustrates a projection 50 that may be formed by pressing a tool into the molten sheet and later upon cooling and removal of the tool, cutting/drilling of the projection to form a loop portion 54. FIG. 3C illustrates a projection 50 that may be formed by pressing a tool into the molten sheet and later upon cooling and removal of the tool, cutting/drilling of the projection to form a “T” portion 56. FIG. 3D illustrates a projection 50 that may be formed by pressing a tool into the molten sheet and later upon cooling and removal of the tool, cutting/drilling of the projection to form an inverted “U” portion 58. It is contemplated that other shapes may be formed and shaped in addition to those shown.

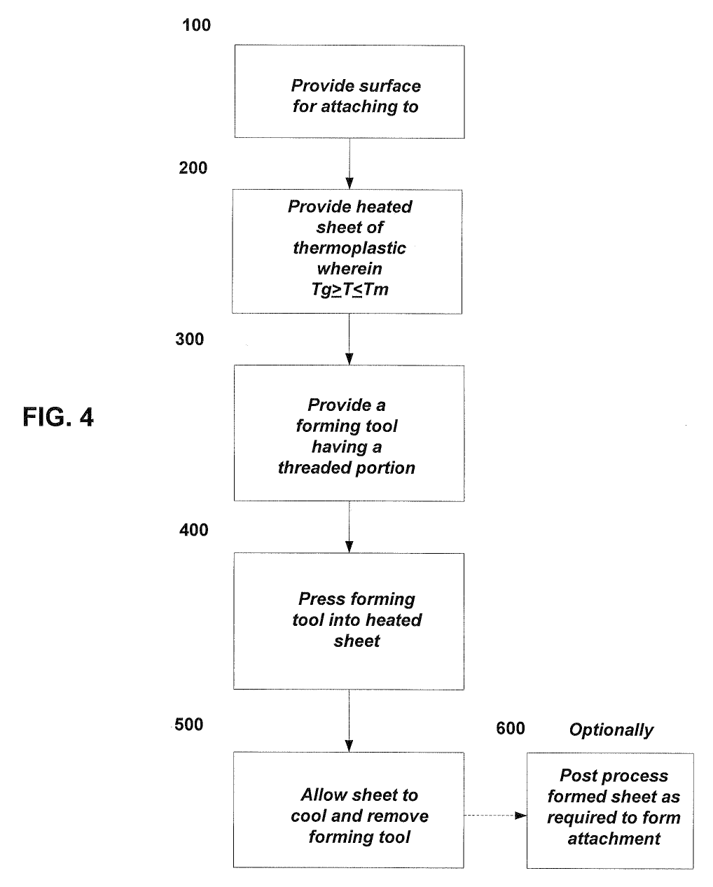

FIG. 4 is a flowchart illustrating one exemplary embodiment for forming the threaded attachment according to the present disclosure, as applied to a polymeric material having semi-crystalline morphology. As shown at 100, a surface may be provided to which attachment is desired. As described above, the surface may be one having a fibrous outer layer, such as a non-woven, woven or knitted fabric or carpeting. As shown at 200, a sheet of thermoplastic polymer approximating the size of the desired attachment may be provided and heated to a temperature, T, that is between the melting temperature, Tm, and the glass transition temperature, Tg, of the semi-crystalline thermoplastic polymer. As noted at 300, a forming tool may be provided having a threaded portion, the tool optionally heated to the temperature of the sheet. At 400, the forming tool may be pressed into the heated sheet such that the sheet and fibrous surface may be joined along a peripheral flange portion and a portion of the heated sheet makes contact with the tooling and is therefore formed into a threaded portion by the forming tool. As noted above, the threaded portion may be present on the raise portion of the sheet.

The sheet may then be allowed to cool (500) to a temperature where the forming tool may be unthreaded from the formed sheet, providing a threaded connection attached to a fibrous surface. It may be appreciated by unthreading the tooling, the threads on the raise portion of the sheet may be preserved and used for subsequent attachment. As shown at 600, in the case where an attachment is being formed that is not threaded but is formed as a projection (FIGS. 3A-3D), post-processing may take place to form a connector, for instance by cutting, drilling or grinding the projection to form a hook, loop, “T” or inverted “U” shape.

The invention has been described in an illustrative manner with respect to presently preferred embodiments, and it is to be understood that the terminology that has been used is intended to be in the nature of words of description rather than words of limitation. Obviously, many modifications and variations of the present invention in light of the above teachings may be made. It is therefore to be understood that within the scope of the appended claims, the invention may be practiced otherwise than as specifically shown and described.

What is claimed is:

1. A fibrous surface including a connector for attaching articles, comprising:
a fibrous surface including fibers protruding therefrom;
a polymeric sheet having a peripheral flange, said flange having a bonding surface to bond to said fibers, wherein said sheet includes a raised portion and said peripheral flange at least partially surrounds said raised portion of said sheet;
said bonding surface of said peripheral flange bonded to said fibrous surface; and
wherein said raised portion of said sheet includes a surface comprising threads.

2. The fibrous surface including a connector of claim 1 wherein said surface comprises a carpeted surface.

3. The fibrous surface including a connector of claim 1 wherein said polymeric sheet comprises an acrylic polymer.

4. The fibrous surface including a connector of claim 1 wherein said bonding comprises fibers embedded in said polymeric sheet.

5. The fibrous surface including a connector of claim 1, wherein said peripheral flange completely surrounds said raised portion of said sheet.

6. The fibrous surface including a connector of claim 1, wherein said polymeric sheet comprises a thermoplastic polymer material.

7. The fibrous surface including a connector of claim 1, wherein said polymeric sheet comprises a polymer selected from the group consisting of polyester, polyolefin, polyurethane, acrylic, modified acrylic, polycarbonate, polyimide, or polysulfone.

8. The fibrous surface including a connector of claim 1, wherein the sheet has a thickness of 0.010 inches to 0.150 inches.

9. A method of forming a threaded connector on a surface, comprising:
providing a surface;
providing a polymeric sheet for forming into a raised portion with a peripheral portion;
heating said sheet to a temperature where said sheet may be formed to include a raised portion and peripheral portion and applying said sheet to said surface;
providing a tool having a threaded portion;
pressing said tool into said heated sheet and forming a peripheral portion of said sheet to contact and bond to said surface, wherein a portion of said sheet is formed into a raised portion; and
unthreading said tooling from said formed sheet.

10. The method of claim 9, wherein said surface includes fibers projecting therefrom and said fibers support said sheet to form said raised portion of said sheet.

11. The method of claim 9, wherein said raised portion of said sheet is formed by drawing a vacuum through said tool.

12. The method of claim 9, wherein said raised portion of said sheet is formed by forcing air through said surface beneath said sheet.

13. The method of claim 9, wherein said sheet is heated to a temperature between Tg and Tm.

14. The method of claim 9, wherein said peripheral flange completely surrounds said raised portion of said sheet.

15. The method of claim 9, wherein said polymeric sheet comprises a thermoplastic polymer material.

16. The method of claim 1, wherein said polymeric sheet comprises a polymer selected from the group consisting of polyester, polyolefin, polyurethane, acrylic, modified acrylic, polycarbonate, polyimide, or polysulfone.

17. The method of claim 9, wherein the sheet has a thickness of 0.010 inches to 0.150 inches.

18. A method of forming a connector on a surface, comprising:
providing a surface;
providing a polymeric sheet for forming into a raised portion with a peripheral portion;
heating said sheet to a temperature where said sheet may be formed to include a raised portion and peripheral portion and applying said sheet to said surface;
providing a tool having a concave portion;
pressing said tool into said heated sheet and forming a peripheral portion of said sheet to contact and bond to said surface, wherein a portion of said sheet is formed into a raised portion; and
removing said tooling from said formed sheet;
forming said raised potion into a connector.

19. The method of claim 18, wherein said peripheral flange completely surrounds said raised portion of said sheet.

20. The method of claim 18, wherein said polymeric sheet comprises a thermoplastic polymer material.
